(19) United States
(12) Patent Application Publication
(10) Pub. No.: US 2007/0197169 A1
(43) Pub. Date: Aug. 23, 2007

(54) Systems and methods for transmitter and channel characterization

(76) Inventor: Marlin E. Viss, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/406,954

(22) Filed: Apr. 18, 2006

Related U.S. Application Data
(60) Provisional application No. 60/764,404, filed on Feb. 1, 2006.

(51) Int. Cl. H04B 17/00

(52) U.S. Cl. 455/67.14

(57) ABSTRACT

A system and method for characterizing components for generating or communicating signals. A predefined test signal, such as a repeating sequence of symbols, or a pseudo-random binary sequence, is generated by a signal transmitter. A reference waveform is generated from the test signal. An acquired waveform is generated by collecting the test signal at a port of the device under test (DUT). A reference spectrum and an acquired spectrum are generated using a discrete Fourier transform. The acquired spectrum is divided by the reference spectrum to generate a scattering parameter spectrum that characterizes the DUT.

### RELATED APPLICATIONS

This application claims priority of U.S. Provisional Patent Application Ser. No. 60/764,404, filed on Feb. 1, 2006, titled TRANSMITTER AND CHANNEL CHARACTERIZATION USING REPEATING DATA SEQUENCES; which is incorporated by reference in this application in its entirety.

### BACKGROUND OF THE INVENTION

1. Field of the Invention

The present invention relates to test and measurement systems, and more particularly to systems and methods for testing communications systems.

2. Description of Related Art

In modern communication systems, high-speed digital signals are typically passed through transmission channels and/or media that are less than ideal. The transmission channel and/or media transmission characteristics may degrade a transmitted original digital signal to the point that a receiver is unable to accurately differentiate between a received zero and/or one in the received digital signal at the receiver. This problem is more acute for communication test systems that are utilized to test and characterize numerous types of electronic devices (generally known as “devices under test” or “DUTs”) because of the need to accurately characterize the DUTs.

A set of measures called “scattering parameters” may be used to characterize DUTs. Methods for measuring the scattering parameters of devices include the use of Network Analyzers, Time Domain Reflectometry (TDR) and Time Domain Transmissometry (TDT). However, these methods suffer from several drawbacks. First, these methods make small signal approximations. Or, in other words, the methods begin with the assumption that the DUT is linear. This assumption may not hold under the actual operating conditions of the DUT. Second, for single port devices the prior art can only measure the return loss. For example, in a typical communication system, a network analyzer or TDR system could measure the transmitter return loss, but not the transmitter insertion loss because the transmitter is a single-port device. Third, these methods cannot perform measurements on active devices; e.g. a transmitter cannot be actively transmitting while return loss is being measured. This is a significant disadvantage, as the scattering parameters are often different when the DUT is active than when it is not active.

There is a need for methods and systems that can perform full channel and transmitter characterization.

### SUMMARY

In view of the above, examples of systems for characterizing transmitters and channels consistent with the present invention include a transmitter configured to generate a predefined test signal, such as a repeating sequence of symbols, or a pseudo-random binary sequence. A reference waveform is generated from the test signal. An acquired waveform is generated by collecting the test signal at a port of the device under test (DUT). A reference spectrum and an acquired spectrum are generated using a discrete Fourier transform (“DFT”). The acquired spectrum is divided by the reference spectrum to generate a scatter parameter spectrum that characterizes the DUT.

Various advantages, aspects and novel features of the present invention, as well as details of an illustrated embodiment thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a block diagram of an example of an implementation of a typical communication system.

FIG. 2 is a block diagram of an example of an implementation of a measurement configuration for transmission insertion loss.

FIG. 3 is a plot of an example waveform produced by the transmitter.

FIG. 4 is a plot of an example reference waveform.

FIG. 5 is a plot of example spectra of reference and acquired waveforms.

FIG. 6 is a block diagram of an example of an implementation of a measurement configuration for lumped insertion loss.

FIG. 7 is a block diagram of an example of an implementation of a measurement configuration for channel S21.

FIG. 8 is a block diagram of an example of an implementation of a measurement configuration for channel S11.

FIG. 9 is a block diagram of an example of an implementation of a measurement configuration for transmitter return loss.

### DETAILED DESCRIPTION

In the following description of preferred embodiments, reference is made to the accompanying drawings that form a part hereof, and which show, by way of illustration, specific embodiments in which the invention may be practiced. Other embodiments may be utilized and structural changes may be made without departing from the scope of the present invention.

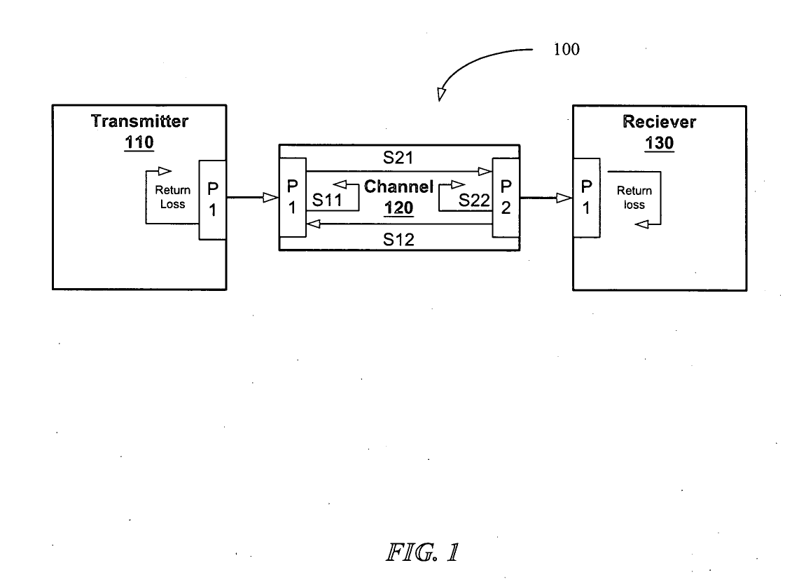

As shown in FIG. 1, a communication system 100 is composed of a transmitter (Tx) 110, a channel 120, and a receiver (Rx) 130. Each component in the system 100 has at least one communications port. The transmitter 110 and receiver 130 have one port each, and the channel has a port 1 and a port 2. Each portion of the system can be characterized by a set of scattering parameters (S-parameters). When all scattering parameters are known, the linear system response to a known input signal may be defined.

The S-parameters may be defined as follows:
S₂₁=Energy exiting port 2/energy incident on port 1. S₂₁ approximates the channel attenuation or insertion loss.
S₁₁=Energy exiting port 1/energy incident on port 1. S₁₁ is also called either return loss or port match.
S₂₂=Energy exiting port 2/energy incident on port 2. S₂₂ is also called either return loss or port match.
S₁₂=Energy exiting port 1/energy incident on port 2.

Although the system shown in FIG. 1 has a single-port transmitter and receiver and a two-port channel, transmission systems can also be differential, defined as the difference between lines A and line B. In this case, the transmitter 110 and receiver 130 would each be two-port devices and the channel 120 a four-port device. The descriptions that follow involve using a single-ended type of system shown in FIG. 1; however, embodiments described below can be extended to differential electrical communication systems.

### Transmitter Insertion Loss

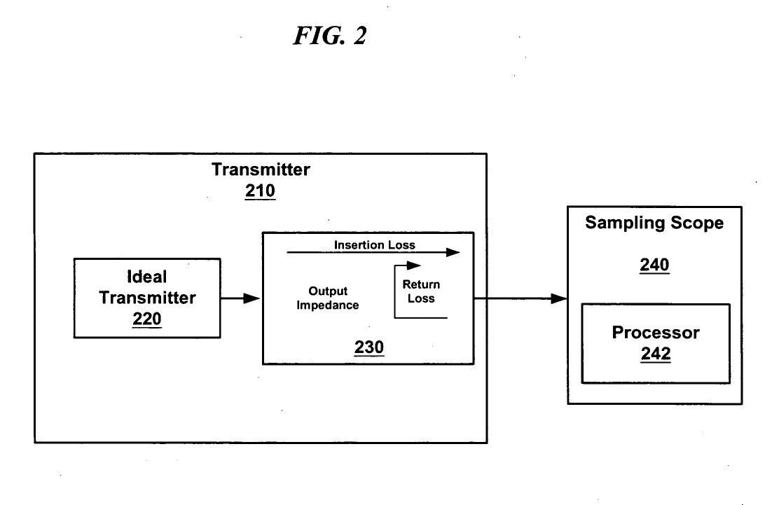

Transmitters (and receivers) are one-port devices and therefore insertion loss cannot be measured. However, transmitters do not produce perfect signals. FIG. 2 shows a transmitter 210 modeled as an ideal transmitter 220 followed by imperfect output impedance 230, which allows for quantification of the insertion loss of the transmitter 210.

To measure the transmitter insertion loss, the transmitter 210 is connected to a measuring device (FIG. 2 shows a sampling scope 240, such as the Agilent 86100C DCA-J). One of ordinary skill in the art will appreciate that any suitable measuring device may be used instead of the sampling scope, such as for example, a real-time scope. The sampling scope 240 in FIG. 2 includes a test input 238, which may include a probe or a cable or any suitable device, to couple to test points on DUTs to collect signals, and a processor 242 for performing calculations on signals measured by the system. The processor 242 may be on a separate device in alternative embodiments. Although not shown, a transmitter clock is connected to the trigger input of the sampling scope 240.

The processor 242 may be any computing device, such as, for example, a microprocessor, microcontroller, application specific integrated circuit (“ASIC”), discrete or a combination of other types of circuits acting as a central processing unit. Although not shown, memory is included in the sampling scope 240 to store data, program functions, and any other information needed to perform operation of the sampling scope 240. The memory may take any form such as EEPROM, ROM or RAM either currently known or later developed, or other machine-readable media including secondary storage devices such as hard disks, floppy disks, and CD-ROMs. The processor 242 and supporting circuitry and memory devices may be on another device, such as a personal computer connected to the sampling scope 240 to collect the data retrieved by the sampling scope 242.

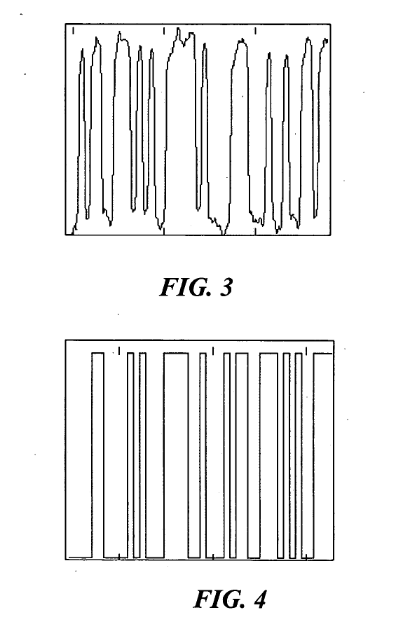

Using the setup shown in FIG. 2, the transmitter insertion loss may be measured by first, configuring the transmitter 210 to transmit a test signal having a known pattern. Such a test signal may be a repeating sequence of symbols. The sequence may be known a priori or it may be determined by the sampling scope 240 using any suitable method, such as a decision threshold. The sequence may be a pseudo-random binary sequence (PRBS). The sampling scope 240 acquires and stores a repeating analog waveform actually produced by the transmitter 210. FIG. 3 shows an example of an acquired waveform.

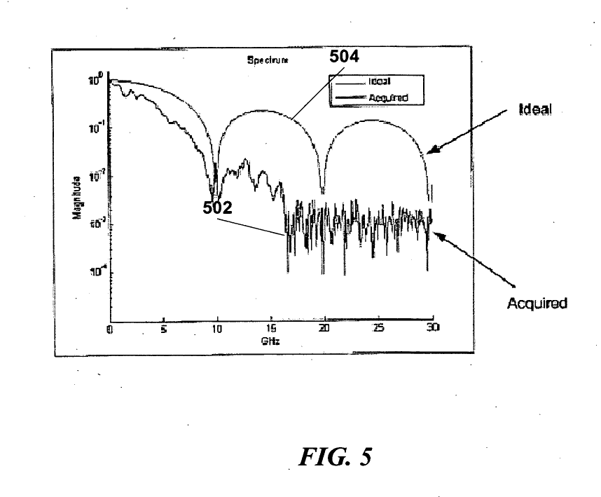

A reference waveform, which represents an ideal waveform, is constructed based on the sequence of symbols transmitted by the transmitter 210 in generating the acquired waveform. FIG. 4 shows an example of a reference waveform. The discrete Fourier transform is applied to both the reference waveform and the acquired waveform. FIG. 5 shows an acquired spectra magnitude 502 and a reference spectra magnitude 504 for the acquired and reference waveforms, respectively.

The transmitter insertion loss is calculated by dividing the acquired spectrum by the reference spectrum. The following equation may be calculated by a program run by the processor 242 (shown in FIG. 2) to generate the transmitter insertion loss:
S₂₁=dft(Measured)/dft(Reference),
where dft(Measured) is the discrete Fourier transform of the acquired waveform, dft(Reference) is the discrete Fourier transform of the reference waveform.

Depending on the bit rate and encoding scheme used by the transmitter, there may be nulls in the reference spectrum. For example, for non-return-to-zero (NRZ) data transmitted at bit rate R, there will be a null at the frequencies R, 2R, 3R . . . The nulls present a problem for the calculated insertion loss because they are in the denominator of the above equation. The nulls that show up in the trace can be resolved in a number of ways, including performing a null-compensation technique including any combination of:

1. Applying a low pass filter to insertion loss with a cutoff before the first null;

2. Applying a comb filter with stop-bands surrounding each null;

3. Not calculating insertion loss at or around each null;

4. Interpolating (magnitude and phase) across each null; and

5. Changing the bit rate and/or encoding scheme such that the nulls appear at different frequencies, then combining the two measures of insertion loss to “fill in the gaps”.

### Lumped Insertion Loss

A similar approach may be used to measure a “lumped” or in-situ insertion loss. The “lumped” insertion loss refers to the transmitter insertion loss, the channel S₂₁, and any interactions between the transmitter return loss and the channel S₁₁. This technique advantageously allows measurements of insertion loss without breaking the connection between the transmitter 220 and the channel 250. One example of the usefulness of this technique involves application specific integrated circuits (“ASICs”). Many ASICs have no access points after the integrated circuits are soldered to printed circuit boards thereby eliminating access to the transmission ends of the channel. This technique provides a way of measuring the lumped insertion loss of such an ASIC and its printed circuit board.

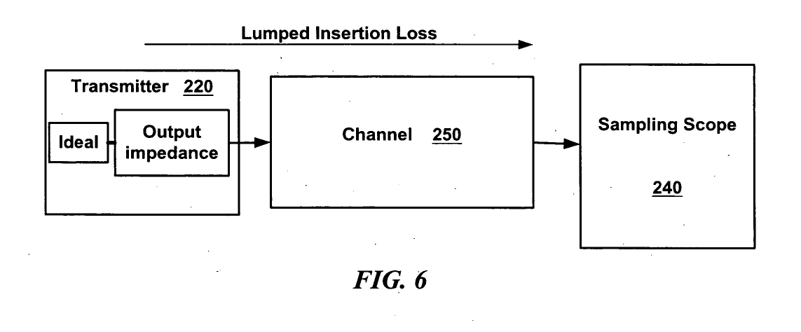

In order to measure lumped insertion loss, the transmitter 220 is connected to the channel 250, which is then connected to the sampling scope 240 as shown in FIG. 6. The transmitter 220 is programmed to generate a repeating sequence of symbols. The sampling scope 240 acquires and stores an acquired waveform of the repeating sequence of symbols actually generated by the transmitter 220. A reference waveform is constructed from the repeating sequence of symbols. Both the reference and acquired waveforms are processed using a discrete Fourier transform. The lumped insertion loss is then generated by dividing the spectra according to the equation for S21 above.

### Channel S₂₁

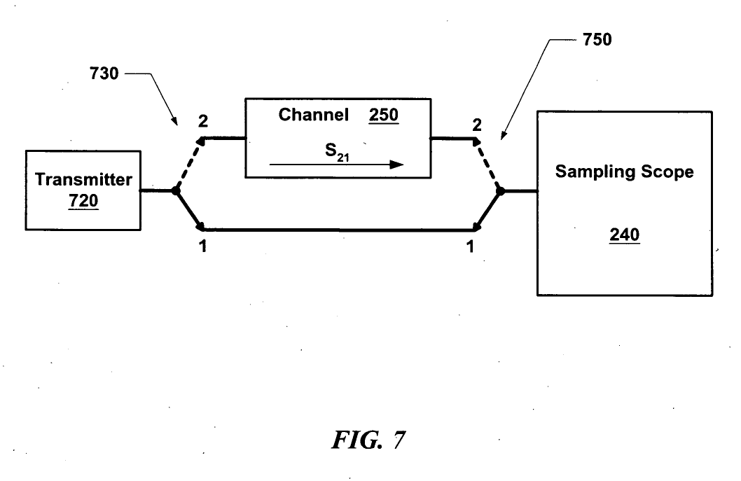

The S₂₁ of the channel 250 independent of the insertion loss of the transmitter 220 can also be obtained. Referring to FIG. 7, a transmitter 720 is connected to the channel 240 via a switch 730 having two positions, 1 and 2. The channel 250 is connected to the sampling scope 240 via a second switch 750 having positions 1 and 2. The transmitter 720 in FIG. 7 is not a DUT, and may be an embedded device, an instrumentation grade pattern generator, or any other device capable of generating a repetitive waveform.

With the system shown in FIG. 7, the S₂₁ of the channel 250 may be determined by first configuring the transmitter 720 to transmit either a repeating sequence of symbols or a repeating analog waveform. The transmitter 720 is connected directly to the sampling scope 240 as shown in FIG. 7 via switch position 1 of the first switch 730 and position 1 of the second switch 750. The repeating sequence of symbols or analog waveform produced by the transmitter 720 is acquired and stored by the sampling scope 240. The stored waveform is the reference waveform.

The transmitter 720 is then connected to the sampling scope 240 as shown in FIG. 7 via position 2 of the first switch 730 and position 2 of the second switch 750. The transmitter 720 generates the repeating waveform, which is then acquired and stored by the sampling scope 240. The stored waveform is the channel waveform. A discrete Fourier transform is then performed on both the reference and the channel waveform to generate a reference spectrum and a channel spectrum. The channel S₂₁ is calculated by dividing the channel spectrum by the reference spectrum. There may be nulls in the reference spectrum; these can be addressed in a manner similar to that described above with reference to determination of the transmitter insertion loss method.

This channel S₁₂ may also be measured by reversing the channel 250 in the system shown in FIG. 7. The transmitter output impedance should be well matched to the channel for accurate S₂₁ measurement results.

### Channel or Receiver S₁₁

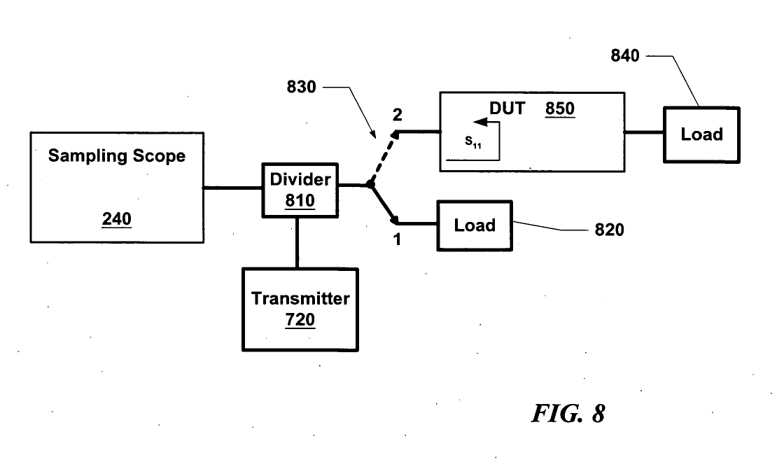

The S₁₁ of a channel or of any single port device such as a receiver may be obtained by connecting the transmitter 720 and the sampling scope 240 to a divider 810, and connecting the divider 810 to a switch 830 as shown in FIG. 8. The switch 830 connects at position 1 to a matched load 820, and at position 2 to a DUT 850. If the DUT 850 is a two port channel, the DUT 850 is connected at port 2 (not shown) to a second matched load 840. Both first and second matched loads 820, 840 are 50 ohm impedances, but the load may be any suitable impedance and one of ordinary skill in the art would be able to select a suitable impedance for a specific implementation.

The transmitter 720 may be an embedded device, an instrumentation grade pattern generator, or any other device capable of generating a repeating waveform. The divider 810 in FIG. 8 may be a three-resistor power divider, or any other suitable power divider having three terminals.

With the components connected as shown in FIG. 8, the DUT's S₁₁ may be determined by configuring the transmitter 720 to transmit either a repeating sequence of symbols or a repeating waveform. The power divider 810 is connected to a matched load, the first 50 ohm load 820, as shown in FIG. 8 via position 1 of the switch 830. The repeating analog waveform incident upon the sampling scope 240 is acquired and stored. The stored waveform is the reference waveform.

The power divider 810 is then connected to the DUT 850 as shown in FIG. 8 via position 2 of the switch 830. The repeating analog waveform incident upon the sampling scope 240 is acquired and stored. The stored waveform is the combined waveform. The reference waveform is subtracted from the combined waveform, and the result is multiplied by two to generate a reflected waveform. A discrete Fourier transform is performed on both the reflected and the reference waveforms. The DUT S₁₁ is then calculated by dividing the reflected spectrum by the reference spectrum. There may be nulls in the reference spectrum; these may be addressed in a manner similar to that described above with reference to the transmitter insertion loss method.

If the DUT 850 is a two port channel, the channel S₂₂ may also be determined by reversing the DUT 850 in the system shown in FIG. 8. Note that the transmitter output impedance and the power divider impedance should be well matched to the channel in order to have a good measure of channel S₁₁.

### Active Transmitter Return Loss

The transmitter return loss may be obtained by connecting the transmitter 220 (as the DUT) to a divider 910 and connecting the divider 910 to the sampling scope 240. The divider 910 is also connected via a three way switch 920 to a matched load 930 at position 1, a short circuit 940 at position 2, and at an open circuit 950 at position 3.

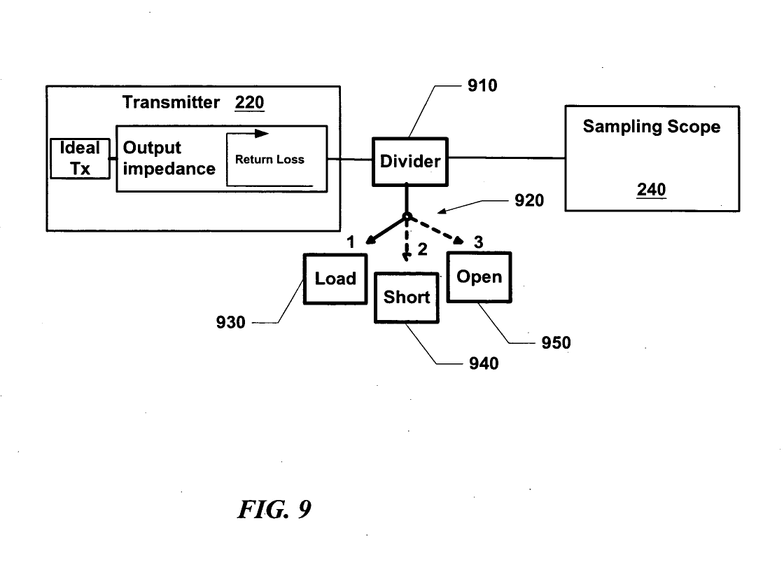

The transmitter return loss may be determined by first configuring the transmitter 220 to transmit a repeating sequence of symbols or a repeating waveform. The power divider 910 is connected to the matched load 930 as shown in FIG. 9 via the switch 920 at position 1. The repeating analog waveform incident upon the sampling scope 240 is acquired and stored. The stored waveform is the reference waveform. The power divider 910 is then connected either to the short 940 (switch position 2 in FIG. 9) or to the open 950 (switch position 3 in FIG. 9). The repeating analog waveform incident upon the sampling scope 240 is acquired and stored. The stored waveform is the combined waveform.

A discrete Fourier transform is performed on both the reference waveform and the combined waveform. The spectra are referred to as “R(ω)” and “C(ω)”, respectively. The transmitter return loss may be calculated, where a combined waveform was generated with the switch 920 at the short (position 2) 940, according to the following equation:

$${Γ}^{short} ( ω ) = \frac{R ( ω ) - \frac{1}{2} R ( ω ) {ⅇ}^{- j ω τ} - C ( ω )}{\frac{1}{4} C ( ω ) {ⅇ}^{- j ω τ}}$$

where “τ” is a time delay associated with the power divider 910. If the combined waveform was generated with the switch 920 at the open (position 3) 950, the transmitter return loss is:

$${Γ}^{open} ( ω ) = \frac{R ( ω ) + \frac{1}{2} R ( ω ) {ⅇ}^{- j ω τ} - C ( ω )}{- \frac{1}{4} C ( ω ) {ⅇ}^{- j ω τ}}$$

There may nulls in the combined spectrum and they may be addressed in a manner similar to that described above with reference to the transmitter insertion loss. Note that the power divider should be a three-resistor type and be well matched to the system impedance to generate accurate transmitter return loss measurements.

### Transmitter Channel Interactions and Aggregate S21

It is desirable to know how a transmitter will interact with downstream components such as a channel or backplane. System performance may be impacted by the transmitter S₂₁ and S₂₂ as well as the channel S₂₁ and S₁₁. The output impedance of the transmitter (S₂₂) and the input impedance of the channel (S₁₁) can interact with each other in ways that may not be anticipated with individual measurements of the two. The S₂₁ technique described can also be applied to a transmitter/channel combination.

The foregoing description of a implementations has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed:

1. A method for characterizing a component having at least one port, the method comprising:
generating a test signal having a test pattern at the port;
receiving the test signal at a measuring device connected to the port;
storing the test signal as an acquired waveform;
generating a reference waveform according to the known pattern of the test signal;
generating an acquired spectrum from the acquired waveform;
generating a reference spectrum from the reference waveform; and
calculating a scatter parameter spectrum for the component by dividing the acquired spectrum by the reference spectrum.

2. The method of claim 1 where the component is a transmitter, the method comprising:
configuring the transmitter to generate the test signal at the transmitter port.

3. The method of claim 1 where the component is a transmitter connected to a channel having a channel port, the method further comprising:
configuring the transmitter to generate the test signal at the transmitter; and
connecting the measuring device to the channel port.

4. The method of claim 1 where the component is a channel having a first port and a second port, where the step of generating the reference waveform comprises the steps of:
connecting a transmitter to the measuring device;
configuring the transmitter to generate the test signal;
receiving the test signal at the measuring device to generate the reference waveform; the method further comprising the steps of:
connecting the transmitter to the first port of the channel;
connecting the second port of the channel to the measuring device; and
performing the steps of generating the test signal, receiving the test signal, and storing the test signal as an acquired waveform.

5. The method of claim 1 where the component is any two-port, or one port device under test (“DUT”), where the step of generating the reference waveform comprises the steps of:
connecting a transmitter to a divider having three terminals at a first terminal;
connecting the measuring device to a second terminal of the divider;
connecting the third terminal of the divider to a matched load;
configuring the transmitter to generate the test signal;
receiving the test signal at the measuring device to generate the reference waveform; the method further comprising the steps of:
connecting the third terminal of the divider to a DUT port;
if the DUT has a second DUT port, connecting the second port of the channel to a second matched load; and
performing the steps of generating the test signal, receiving the test signal, and storing the test signal as an acquired waveform.

6. The method of claim 1 further comprising:
searching the reference spectrum for nulls; and
applying a low frequency filter to the reference spectrum with a cutoff at the first null detected in the reference spectrum.

7. The method of claim 1 further comprising:
searching the reference spectrum for nulls; and
applying a comb filter to the reference spectrum having stop-bands at each null detected in the reference spectrum.

8. The method of claim 1 where during the step of calculating the scatter parameter spectrum, performing the steps of:
determining if there is a null at a given frequency in the reference spectrum; and
for that given frequency, using a non-zero number for the reference spectrum in the step of dividing the acquired spectrum by the reference spectrum.

9. The method of claim 1 where during the step of calculating the scatter parameter spectrum, performing the steps of:
for each frequency in the reference spectrum, determining if there is a null at a given frequency in the reference spectrum; and
for that given frequency, interpolating the scatter parameter spectrum at the null.

10. The method of claim 1 further comprising:
after the calculating step, changing the test signal to generate either at a different bit rate or a different encoding scheme;
performing all of the steps using the changed test signal to generate a second scatter parameter spectrum; and
combining the first and second scatter parameter spectra such that nulls for each scatter parameter spectra are filled with non-null values.

11. A method for characterizing a transmitter, the method comprising:
connecting the transmitter to a divider having three terminals at a first terminal;
connecting a measuring device to a second terminal of the divider;
connecting the third terminal of the divider to a matched load;
configuring the transmitter to generate a test signal having a test pattern;
receiving the test signal at the measuring device to generate a reference waveform;
connecting the third terminal of the divider to a short circuit;
generating the test signal and receiving the test signal at the measuring device;
storing the test signal as a combined waveform;
generating a reference spectrum, R(ω), by performing a discrete Fourier transform on the reference waveform;
generating a combined spectrum, C(ω), by performing a discrete Fourier transform on the combined waveform; and
generating a transmitter return loss spectrum by:
$${Γ}^{short} ( ω ) = \frac{R ( ω ) - \frac{1}{2} R ( ω ) {ⅇ}^{- j ω τ} - C ( ω )}{\frac{1}{4} C ( ω ) {ⅇ}^{- j ω τ}} ,$$
where the test signal was measured with the third terminal of the divider at the open circuit; or
$${Γ}^{open} ( ω ) = \frac{R ( ω ) + \frac{1}{2} R ( ω ) {ⅇ}^{- j ω τ} - C ( \ddot{ω} )}{- \frac{1}{4} C ( ω ) {ⅇ}^{- j ω τ}} ,$$
where the test signal was measured with the third terminal of the divider at the short circuit;
where “τ” is a time delay associated with the divider.

12. The method of claim 11 further comprising:
searching the combined spectrum for nulls; and
performing a null-compensation technique to the generated transmitter return loss spectrum.

13. A system for characterizing a component having at least one port, the system comprising:
a signal source for generating a test signal having a test pattern at the port;
a signal measuring device for acquiring and storing an acquired waveform of the test signal generated by the signal source;
a reference signal generator for generating a reference waveform according to the test pattern of the test signal at the port; and
a processor for calculating a scatter parameter spectrum according to the following:
S=dft(Measured)/dft(Reference), where dft(Measured) is the discrete Fourier transform of the acquired waveform, dft(Reference) is the discrete Fourier transform of the reference waveform.

14. The system of claim 13 where the component is a transmitter having the signal source to generate signals for transmitting out the port.

15. The system of claim 13 where the component is a transmitter and a channel connected to one another, the transmitter having the signal source to generate signals for transmitting out the port to the channel, the channel having a first and second channel ports, the first channel port connected to receive the signal from the transmitter, the second channel port connected to the measuring device.

16. The system of claim 13 where the component is a channel, the system further comprising a transmitter configurable to generate the test signal, where the transmitter is connected to the measuring device directly to generate the reference waveform, and then to the channel, the channel being connected to the measuring device to generate the acquired waveform.

17. The system of claim 13 where the component is a channel, the system further comprising:
a transmitter configurable to generate the test signal; and
a three-terminal divider, where a first terminal is connected to the transmitter, a second terminal is connected to the measuring device, and the third terminal is connected:
first, to a matched load to generate the reference waveform; and
second, to the channel, the channel being further connected to a second matched load, to generate the acquired waveform.

18. A system for characterizing a transmitter configurable to generate a test signal having a test pattern at a port, the system comprising:
a three-terminal divider, a first terminal of the three-terminal divider connected to a two-position switch where a first position is connected to a matched load and a second position is connected to either an open or a short circuit, a second terminal of the three-terminal divider being connected to the transmitter;
a signal measuring device connected to a third terminal of the divider for acquiring and storing a reference waveform of the test signal when the two position switch is set to the matched load and a combined waveform when the two position switch is set to either the open or short circuit; and
a processor for calculating a transmitter return loss spectrum according to the following:
generating a reference spectrum, R(ω), by performing a discrete Fourier transform on the reference waveform;
generating a combined spectrum, C(ω), by performing a discrete Fourier transform on the combined waveform; and
generating a transmitter return loss spectrum by:
$${Γ}^{open} ( ω ) = \frac{R ( ω ) + \frac{1}{2} R ( ω ) {ⅇ}^{- j ω τ} - C ( ω )}{- \frac{1}{4} C ( ω ) {ⅇ}^{- j ω τ}} ,$$
when the combined waveform is acquired with the two position switch set to the open circuit; or
$${Γ}^{short} ( ω ) = \frac{R ( ω ) - \frac{1}{2} R ( ω ) {ⅇ}^{- jωτ} - C ( ω )}{\frac{1}{4} C ( ω ) {ⅇ}^{- jωτ}} ,$$
when the combined waveform is acquired with the two position switch set to the short circuit;
where “τ” is a time delay associated with the divider.

19. A system for characterizing a transmitter configurable to generate a test signal having a test pattern at a port, the system comprising:
a three-terminal divider, a first terminal of the three-terminal divider connected to a two-position switch where a first position is connected to a matched load and a second position is connected to a short circuit, a second terminal of the three-terminal divider being connected to the transmitter;
a signal measuring device connected to a third terminal of the divider for acquiring and storing a reference waveform of the test signal when the two position switch is set to the matched load and a combined waveform when the two position switch is set to the short circuit; and
a processor for calculating a transmitter return loss spectrum according to the following:
generating a reference spectrum, R(ω), by performing a discrete Fourier transform on the reference waveform;
generating a combined spectrum, C(ω), by performing a discrete Fourier transform on the combined waveform; and
generating a transmitter return loss spectrum by:
$${Γ}^{short} ( ω ) = \frac{R ( ω ) - \frac{1}{2} R ( ω ) {ⅇ}^{- jωτ} - C ( ω )}{\frac{1}{4} C ( ω ) {ⅇ}^{- jωτ}}$$
where “τ” is a time delay associated with the divider.

20. A measuring device for detecting signal waveforms comprising:
a probe for sensing electrical signals from devices under testing (DUT);
a storage device having memory for storing a reference waveform, an acquired waveform, a reference spectrum, and an acquired spectrum for signals sensed by the probe;
a processor for performing programs that execute the following steps:
a discrete Fourier transform on the reference waveform to generate the reference spectrum;
a discrete Fourier transform on the acquired waveform to generate the acquired spectrum; and
a spectral parameter calculation by dividing the acquired spectrum by the reference spectrum.

21. A measuring device for detecting signal waveforms comprising:
a probe for sensing electrical signals from devices under testing (DUT);
a storage device having memory for storing a reference waveform, a combined waveform, a reference spectrum, and a combined spectrum for signals sensed by the probe, the combined waveform being acquired with a shorted load or an open load and the reference waveform being acquired with a matched load;
a processor for performing programs that execute the following steps:
a discrete Fourier transform on the reference waveform to generate the reference spectrum;
a discrete Fourier transform on the combined waveform to generate the combined spectrum; and
a spectral parameter calculation by one of the following:
$${Γ}^{short} ( ω ) = \frac{R ( ω ) - \frac{1}{2} R ( ω ) {ⅇ}^{- jωτ} - C ( ω )}{\frac{1}{4} C ( ω ) {ⅇ}^{- jωτ}} ,$$
when the combined waveform is sensed at a shorted load; or
$${Γ}^{open} ( ω ) = \frac{R ( ω ) + \frac{1}{2} R ( ω ) {ⅇ}^{- jωτ} - C ( ω )}{- \frac{1}{4} C ( ω ) {ⅇ}^{- jωτ}} ,$$
when the combined waveform is sensed at an open load;
where “τ” is a time delay associated with the divider.
